(19) United States
(12) Patent Application Publication
(10) Pub. No.: US 2002/0055835 A1
(43) Pub. Date: May 9, 2002

(54) System and method for integrated communications, funds transfers, confirmation and e-commerce applications

(76) Inventors: Luis G. Carcoba Olivares, Zapopan (MX); Sergio Paniagua Webb, Guadalajara (MX); Alvaro Mauricio Gallardo Tamoyo, Guadalajara (MX); Gerardo Carcoba Olivares, Garza Garcia (MX)

Correspondence Address: PEPPER HAMILTON, 600 FOURTEENTH STREET NW, WASHINGTON, DC, 20005, US

(21) Appl. No.: 09/906,616

(22) Filed: Jul. 18, 2001

Related U.S. Application Data
(60) Provisional application No. 60/243,277, filed on Oct. 26, 2000.

(51) Int. Cl. G06F 17/27

(52) U.S. Cl. 704/9

(57) ABSTRACT

A system and method for managing financial and other data in a communications network designed to overcome language, cultural, education, financial and other barriers, is disclosed. The communications network includes one or more communication and transaction centers in the form of web-enabled kiosks, automatic teller machines, personal computers, television set-up boxes, customer activated terminals and the like, for transmitting electronic funds transfer and messaging data.

### PRIORITY

This application claims priority to the provisional patent application entitled, “System and Method for Integrated Communications, Funds Transfers, Confirmation and E-commerce Applications”, Ser. No. 60/243,277, filed Oct. 26, 2000.

### FIELD OF INVENTION

The present invention relates generally to electronic funds transfer and messaging technologies. More particularly, the present invention relates to a system and method for managing financial and other data in a communications network designed to overcome language, cultural, education, financial and other barriers. It relates to a communication and transaction center in the form of an integrated system of web enabled kiosks, Automatic Teller Machines (ATMs), person computers (PCs), television set-up boxes, cellular telephones, wireless devices and/or Customer Activated Terminals (CATs) and the like, used to access the Internet, that facilitate interaction among individuals and entities located in different geographical areas.

### BACKGROUND OF THE INVENTION

As societies become more diverse through changes in such factors as inter- and intra-national mobility, and through growth of international products, services, and labor markets, a variety of technologies and systems have developed to accommodate the continuing need for communication to foster human and community relations and transactions among individuals and entities that are separated by geographical, national or international borders. Various technologies and systems have been developed that partially address communication and transaction needs. The following prior patents represent the state of the art, and are hereby incorporated by reference.

U.S. Pat. No. 5,604,341 to Grossi et al. discloses the use of Automatic Teller Machines (“ATMs”) as video conferencing stations.

U.S. Pat. No. 5,448,043 to Nakano et al. discloses a foreign remittance terminal apparatus for sending money to foreign countries, which includes lobby terminal equipment operated by a user, and counter terminal equipment operated by a teller and connected to a host computer.

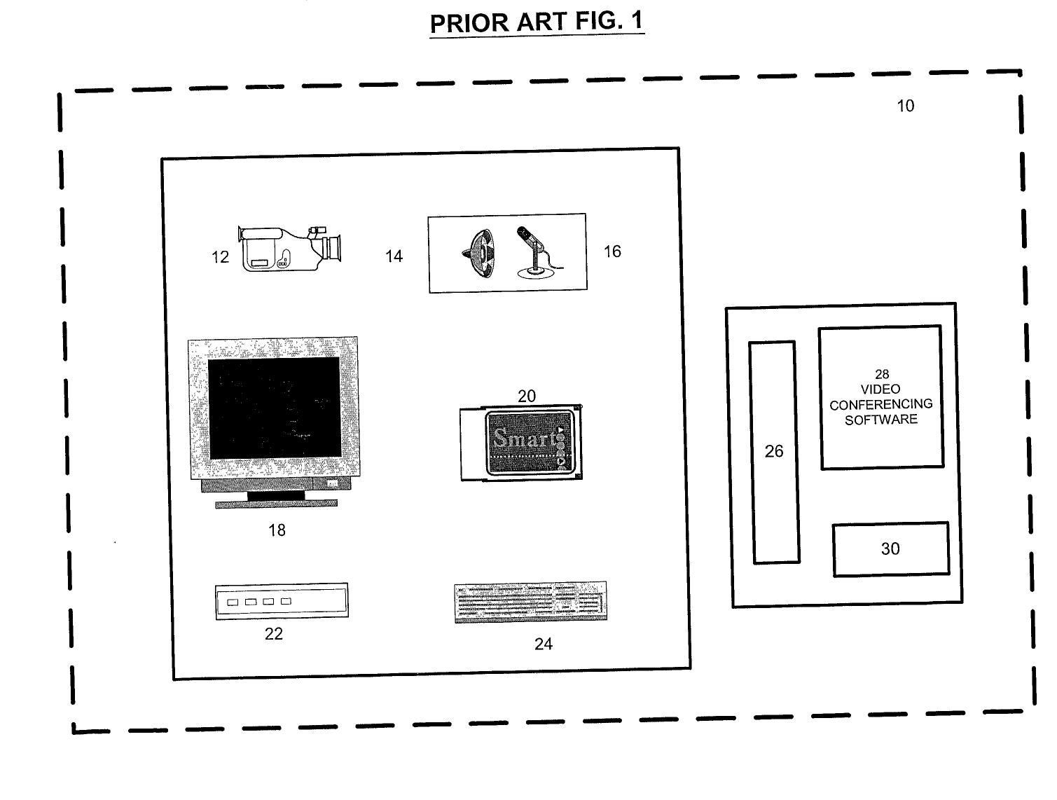

None of the above-mentioned systems provide a fully-integrated and full featured communication and transaction system. For example, in the above ATM disclosure, see also Prior Art FIG. 1, the ATM station 10 is equipped with video conferencing equipment that allows a customer to establish a video conference with an officer of a bank, or with another ATM, or with any other station equipped with compatible video conferencing equipment. ATM station 10 includes, among other things, a video camera 12, an audio speaker 14, an audio microphone 16, a video display 18 to display information to the user, a magnetic card reader 20 for reading ID cards, a dispenser 22 for dispensing currency, and a keypad 24 for entering data. Station 10 also includes a personal computer 26, video conferencing software 28 and a modem 30.

Although ATM station 10 has a form of image-assisted transaction capability, it lacks the efficiencies and important options offered by the present invention.

In addition, the wire-transfer method for money transfer between financial institutions incurs unnecessary delays in the input, transmission, authentication and execution by the recipient business. For example, this traditional method requires the requesting party to provide identification information that is inputted and then transmitted by the local financial institution for authentication and approval by the customer's home financial institution. Thus, several opportunities are created for errors to occur that may subsequently result in a delay in the customer's request. Should errors occur, manual intervention and investigation then becomes necessary.

In short, the prior art systems tend to isolate transactions, provide limited options, and generally do not lead to the user's enjoyment of a more complete experience of communication and information exchange.

Accordingly, there is an increasing need among individuals or institutions that seek to establish or maintain connections with individuals or institutions in foreign locations, for a system that achieves multiple communications features such as personal video image and audio enhanced communications, financial transaction capabilities, graphic and written information specific to a given locality, and also offers opportunities for the advertisement, sale and purchase of products and services.

### SUMMARY OF THE INVENTION

Although not limited to international communication and transactions, an important goal of the present invention is to provide a system for either or both enhanced funds transfer and messaging capabilities among individuals in different countries and cultural and commercial exchanges across borders.

In accordance with the present invention, advanced technology is employed to provide, either all together or each one by itself, a number of features and advantages such as: audio visual messaging; audio and video conferencing; transfers of funds at appropriate exchange rates and other financial transactions; information on events and activities of interest to the users; conditions, news and events in a specific locality; and the offering and purchasing of products and services from merchants or third parties and from the users themselves; all of this with the support of a user friendly interface with audio and visual instructions executed on a touch screen display or similar device.

An extension of the communication and transactions capabilities of the present invention includes more complex operations being facilitated by each communication and transaction center. In one embodiment, for example, the communication and transaction center includes a call center and an on-site assistant to provide assistance to customers unable to deal with all possible transaction options without outside assistance.

The present invention permits visual and audio communications between remotely located individuals, such as distant relatives or friends, plus the convenient and reliable transfer of funds by one person to another person. This is accomplished in a way that also allows the exchange of local information and news to the distant relative or friend, for example, from his/her local or hometown. Additionally, such communications and transactions occur in a user-friendly, readily understood manner.

More particularly, the present invention relates to a system and method for transmitting funds transfer requests and messages together through an automated Communication and Transaction Center (CTC). Authorized users are assigned personal identification numbers (PINs) and/or passwords through biometric or other authentication methods, for easy access to funds and messages via each automated Communication and Transaction Center. Alternatively and optionally, the automated communications and transaction center may embody the form of a company office or financial institution where some of the CTC transaction will be performed directly by employees of the company or the financial institution.

Regarding the transfer of funds, the present invention relates to the capability to automatically prepare all the forms required to perform or effect the transfer of funds using the information contained in the system's records or databases. Since transferring of funds to foreign countries can be performed only by financial institutions qualified to transact foreign remittance business, the present invention efficiently effects such transfers as well.

The overall system of the present invention comprises a communications network of Communication and Transaction Centers in the form of web-enabled kiosks, Automatic Teller Machines (ATMs), Personal Computers (PCs), television set-up boxes (to access the Internet), cellular telephones, wireless devices and/or Customer Activated Terminals (CATs) connected to the Internet through broadband communications, dial-up connections, cache servers, and the like.

The present invention further comprises: a central data management system including an easy-to-use user interface software preferably operated by a touch screen with audio, visual and audio instructions application software; an application software for sending video and audio data; an application software for financial transactions; an application software for content management; and sender and recipient customer database(s) for storing and processing information (including pictures) on the users, recipients and referrals, and banks or financial institutions.

The following summary provides a description of a number of inventive features and advantages of the present invention.

One advantage provides for easy and convenient user-to-user personal and business relations in that each CTC provides a number of communication, information and transaction options to users. In a preferred embodiment, each user is able to communicate, with a choice of accompanying images, with other individuals or users in one or more distant locations, accomplish financial transactions, obtain information related to specific locales, review advertising, engage in purchase and sales activities, and the like, with or without assistance from an onsite personnel or a remote call center. Moreover, each user can obtain benefits for the frequent and loyal use of the services provided by this invention.

One feature of the present invention is the availability, on demand or automatically, of multi-lingual input and output capabilities in financial transactions, including financial transaction involving exchange rates. This feature is intended to create a user environment that readily accommodates cross-cultural and cross-language requirements of the users. It may also allow for more accurate assessment of currency exchange rate information that can be used in decision-making by non-English users as to whether or not to engage in particular transactions. Alternatively and optionally, a secure mode feature can be provided for financial transactions and communications.

Yet another advantage of the present invention enables users to engage in audio/tele/video communications, including video-conferencing, personal messages recorded with audio and/or video, and the transmission or receipt of selected images or information with or without voice or audio component. Such communications can be used, for example, to initiate, confirm, or seek information on transactions or on user interests, and/or to dialogue with users themselves, acquaintances, business associates, service providers, product sellers or the like.

Yet another feature of the present invention provides advertisement as well as buying and selling capabilities to users. Authorized users can select categories of products or services (e.g. hotel accommodations, museums, map services, local newspapers, electro-domestic goods, furniture, groceries, medicines, etc.), and be able to access information or advertisements relating to the selected categories.

Linking capabilities to sites of advertisers is also available to users for direct access to additional information or to perform desired transactions at each kiosk, ATM, PC, TV, cellular telephones, wireless devices and/or Customer Activated Terminals (CATs). Also, users are able to buy and sell select categories of products or services amongst themselves.

Yet another feature of the present invention is the creation of easily-accessible information gathering capabilities throughout a region with respect to specific locales, events, news developments, etc., through such means as, e.g., web content delivery and searching capabilities from places within or without the same country.

Another feature of the present invention provides electronic mail communications capabilities. Another feature of the present invention provides an easy-to-use and efficient identification and authentication of users by employing automated devices, such as magnetic cards, personal identification numbers (PINs), and biometric authentication, including facial recognition and the like.

Another advantage of the present invention allows customers to customize use of each Communication and Transaction Center via, for example, a customer-defined database.

Another advantage of the present invention facilitates the transfers of funds via use of cash, credit card, debit card, smart card and/or electronic wallets.

Another feature of the present invention includes a Loyal Customer Program designed to provide incentivized benefits to recurring users of a Communication and Transaction Center. These benefits may be in the form of discounts, promotions, special offers, and the like.

Another feature of the present invention includes a Customer Referral Program designed to provide incentivized benefits to users who increasingly refer people to use Communication and Transaction Center services.

Another advantage of the present invention is its user-friendliness and simplicity; it can be understood and accessed by individuals having no special expertise in computers, telecommunications, money transfers, wire transfers and the like. The whole system is accurate, convenient and customer friendly with the support of audio, visual and image instructions.

Moreover, a recipient-user of the present invention is not required to have or own a bank account in order to receive transferred funds. Nor is the recipient-user required to share or use the same bank or financial institution affiliation of the sender. The cash, or cash equivalent, is issued directly to the designated recipient.

A further advantage of the present invention includes the various safeguards and features designed to assure that only authorized individuals gain access to the proper accounts and funds.

Further features and advantages of the present invention include provision of a system that: is reliable and easily maintained; can be located in various high pedestrian traffic locations; can be monitored from a central remote location; can be easily exported to provide additional services and customer-added value services; is cost effective from both manufacturer and consumer points of view; and provides lower customer transaction fees with direct marketing and promotional programs to foster customer loyalty and encourage referrals.

Yet another feature of the present invention provides for electronic funds transfer whereby cash, cash equivalents and/or other desired dispensed documents (e.g. tickets, stamps, etc.) is/are issued directly to the designated recipient.

In one embodiment of the present invention a communication and transaction system for transferring funds and message data, is disclosed. The system comprises one or more multi-lingual interpreters and translators; one or more foreign remittance transaction systems comprising processors, hard and soft devices, senders and receivers; and one or more data managers for storing, processing and managing financial and communications data.

The data manager may comprise a customer database, for storing and processing customer preference and personal interest information. The customer database is configured for storing and processing images. The data manager may also comprise a user interface, which may constitute a touch screen having at least an audio and/or visual and audio instructions application software. The user interface may also constitute a screen having a keyboard, mouse or tracking ball, where the screen includes audio and/or visual and audio instructions application software.

Preferably, the touch screen of each Communication and Transaction Center displays video messages on a portion or all of the touch screen. On the other portions or in different screens of the touch screen that do not show a video message, other information of interest to the user can be displayed, such as the desired and/or actual transfer amount, news of customers interests, new products, advertisements, etc.

A minimal but required number of operator actions, such as touch screen pushes or keystrokes, are required for each funds transfer and/or messaging transaction so the operation can be understood, disclosed to and authorized by the operator, user, sender and/or recipient.

The data manager may also comprise a communications system for transmitting video and/or audio and/or video and audio data. The communications system comprises an authentication system, which employs biometrics authentication, for identifying and authenticating a recipient of message data. The communications system may also comprise a video conferencing system, for direct real time communications accompanied by video and audio data, as well as an electronic mail system and/or an audio communication system.

The data manager may also comprise a remittance transaction system for processing money transactions either through the use of physical items like currency, bills, credit cards, etc. and/or interactions with electronic transaction system.

The foreign remittance transaction system may comprise an authentication system for identifying and authenticating a recipient of a fund transfer. The authentication system employs either a PIN, a password and official ID and/or a biometrics authentication. It also comprises an international currency exchange rate system capable of efficiently transacting international fund transfers.

The foreign remittance transaction system minimizes the time and labor required for a sender to fill out an application form for foreign remittance, because all the personal information from the sender and the receiver will be pulled from a database in the management system where the sender and/or receiver previously had filled his/her personal information and minimizes the time and labor required for a teller to check each item of an application form for foreign remittance.

The data manager may also comprise a content management system, the content management system will identify from the database in the management system the geographical location from where the sender and/or receiver comes from and will display information and news of their personal interest from such place. In yet another embodiment of the present invention a method of using an interactive communication and transaction center for funds transfer, is disclosed. The method comprises the steps of: entering identifying user data into the communication and transaction center; determining each authorized user upon access to the CTC; presenting each user with news, data or other information pertaining to the user's interest; performing a system check for pending fund transfer transactions associated with the user; performing a system check for pending messages data associated with the user; presenting the user with service options for selection as desired; and processing and providing a record of each fund transfer transaction selected.

The step of entering identifying data may include the step of providing either an identification card or biometrics identifier, or touching a display screen. In addition, the step of determining each authorized user may include the step of using, singly or in combination, personal identification number(s), password(s) and/or biometrics authentication.

In yet another embodiment a communication software suite is disclosed. The suite comprises a multi-lingual system for accommodating cross-language and cross-cultural user requirements; the multi-lingual systems will identify from the database in the management system the preferred language of the sender and receiver and will display all information in the form of news, instructions, disclosures, contracts and any other mean in the preferred language of the sender and/or receiver; a foreign remittance transaction system for accessing and processing financial data; a direct funds delivery system, having a secured funds delivery system, for authorized transfer of financial and other data; and a data management system for storing, processing and managing data.

There has thus been outlined rather broadly the more important features of the invention in order that the detailed description thereof that follows may be better understood, and in order that the present contribution to the art may be better appreciated. There are, of course, additional features of the invention that will be described below and which will form the subject matter of the claims appended thereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein as well as the abstract included below are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF PREFERRED EMBODIMENTS

FIG. 1 shows a block diagram of components of a conventional automated teller machine (ATM) system with video conferencing capabilities.

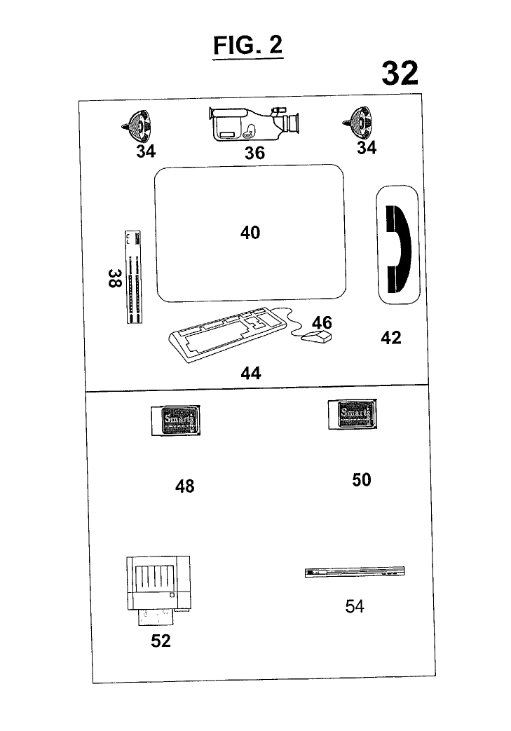

FIG. 2 shows a block diagram of the components included in a Communication and Transaction Center, in accordance with one embodiment of the present invention.

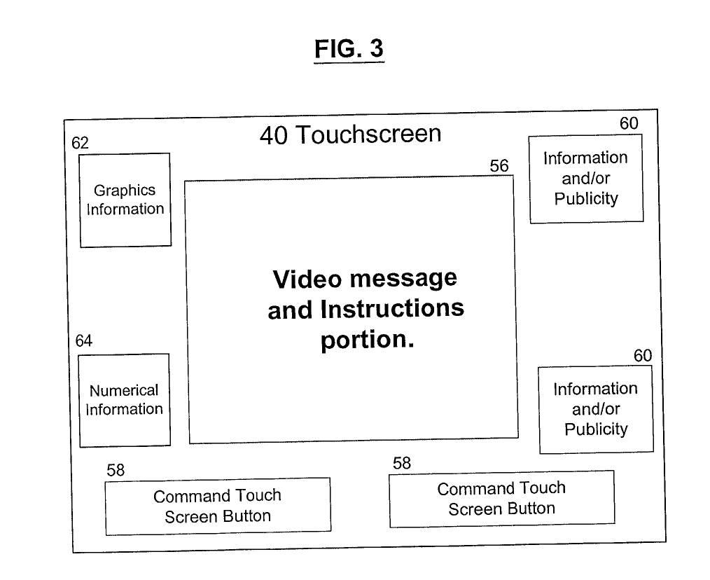

FIG. 3 shows one example of a touch screen display usable with the Communication and Transaction Center of FIG. 1.

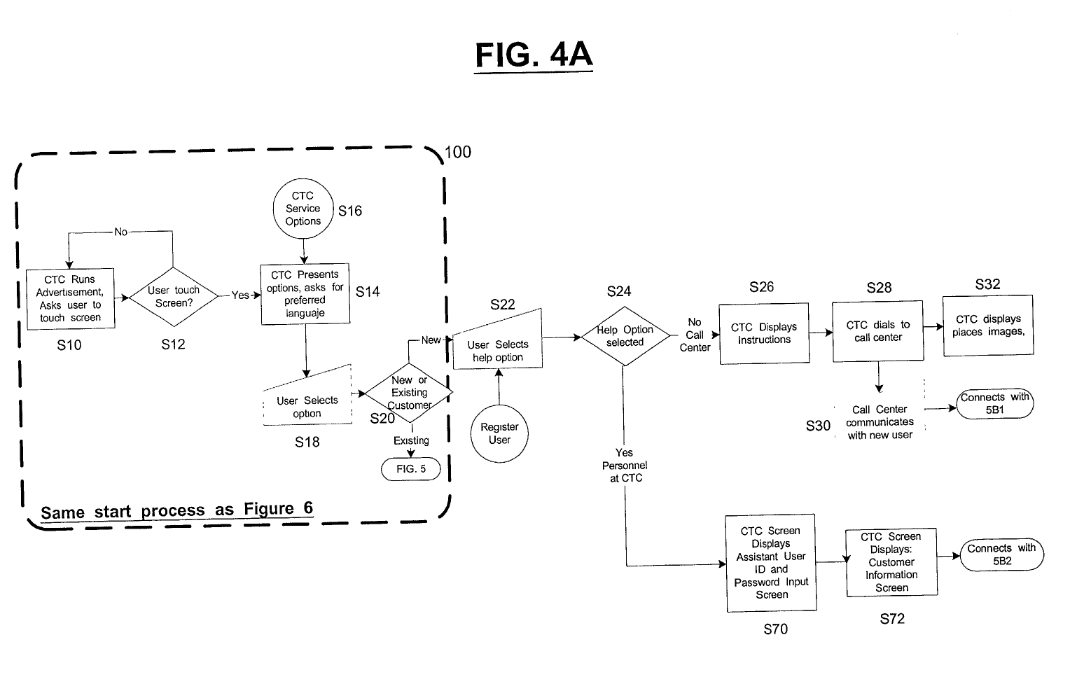

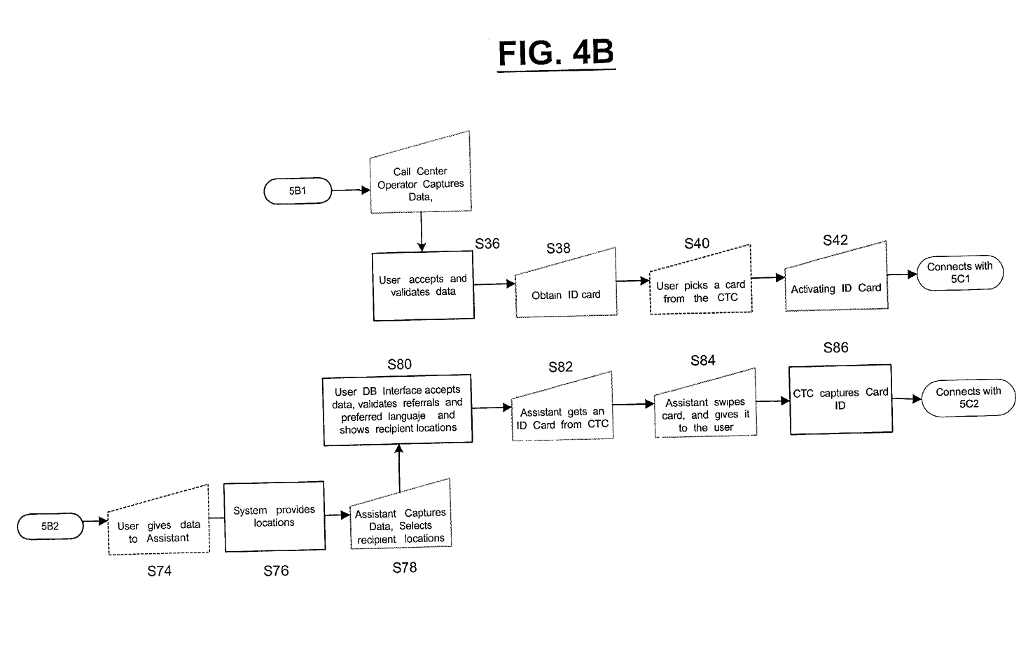

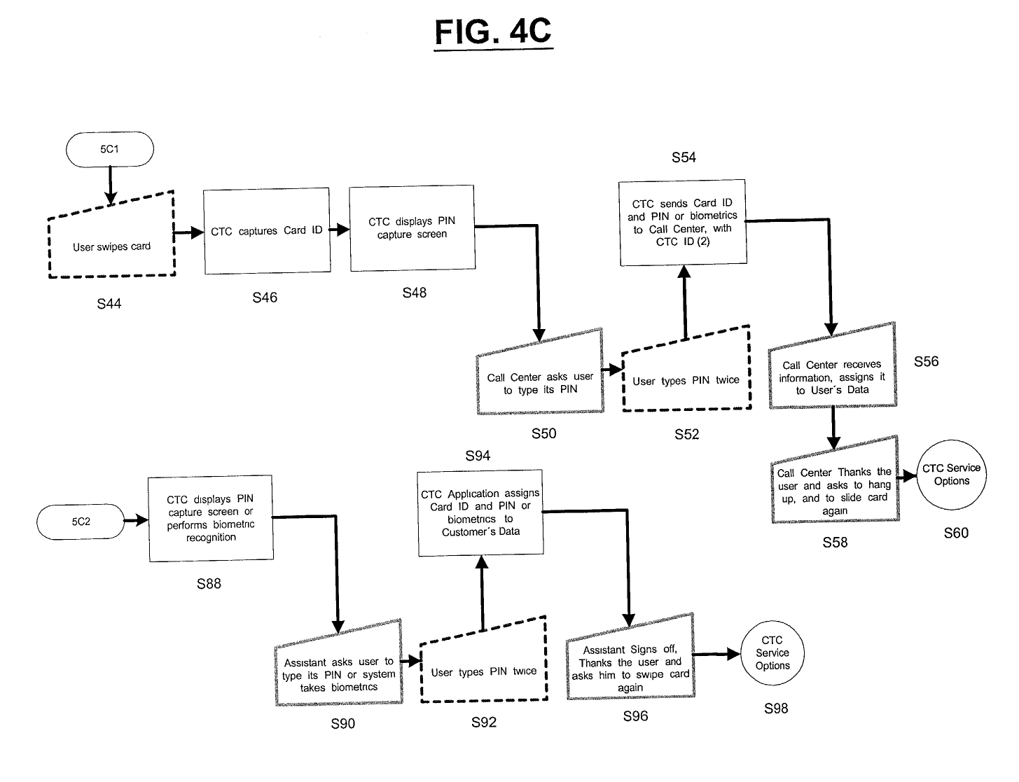

FIGS. 4A, 4B and 4C show a flow chart of the process of a new user creating a personal profile, according to a preferred embodiment of the present invention.

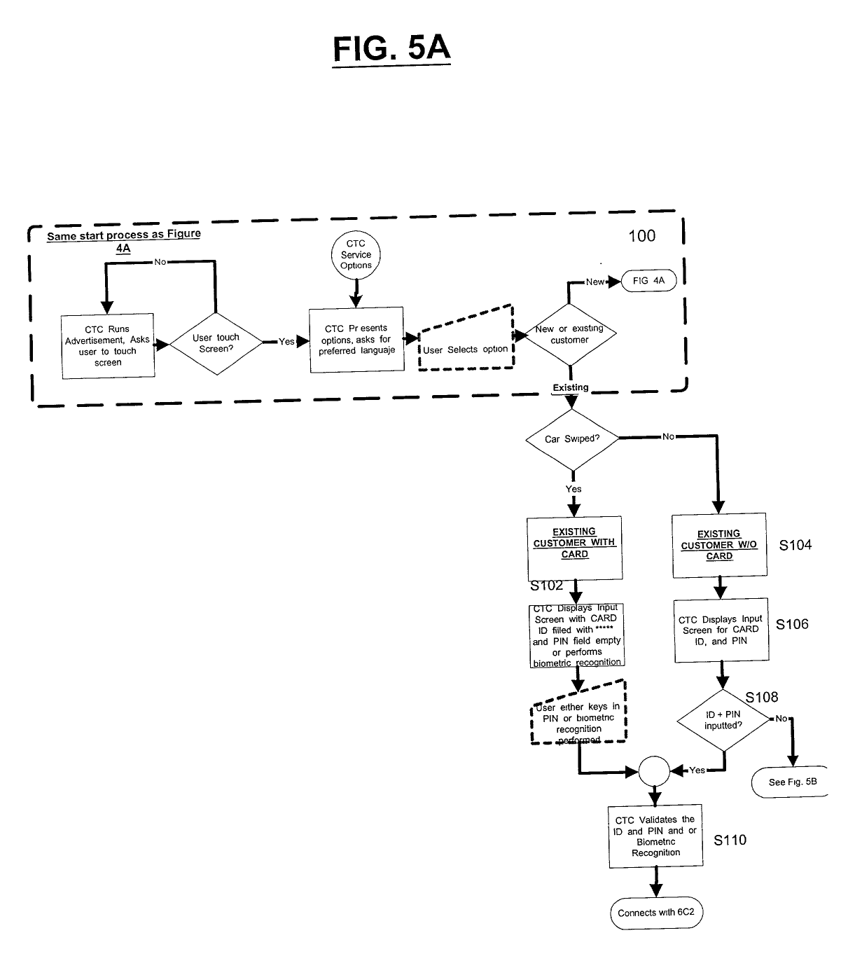

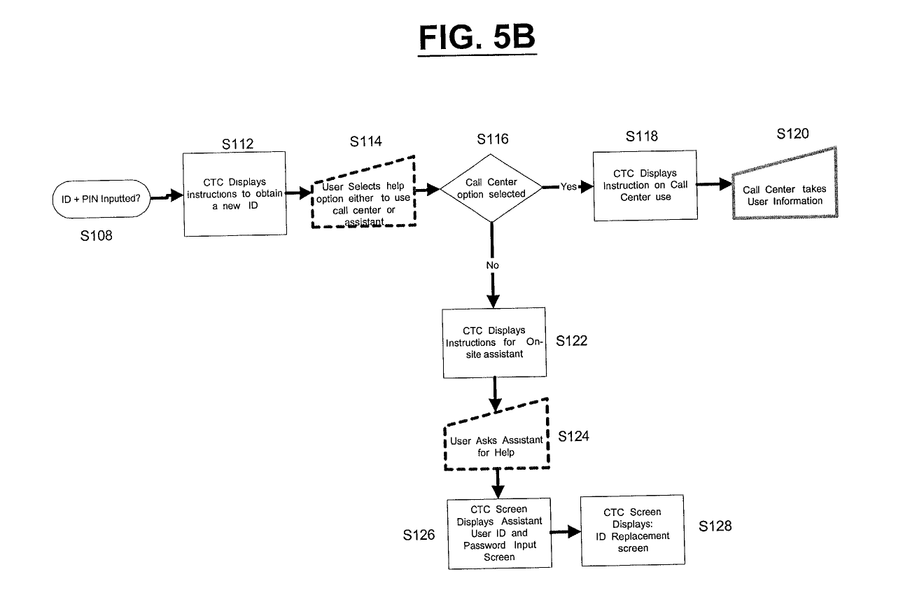

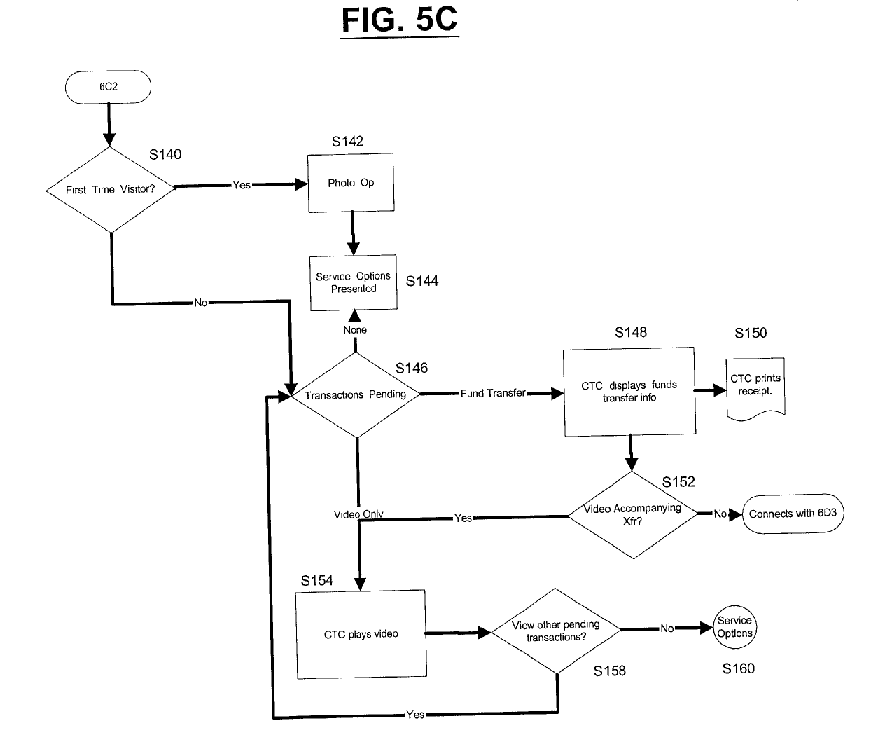

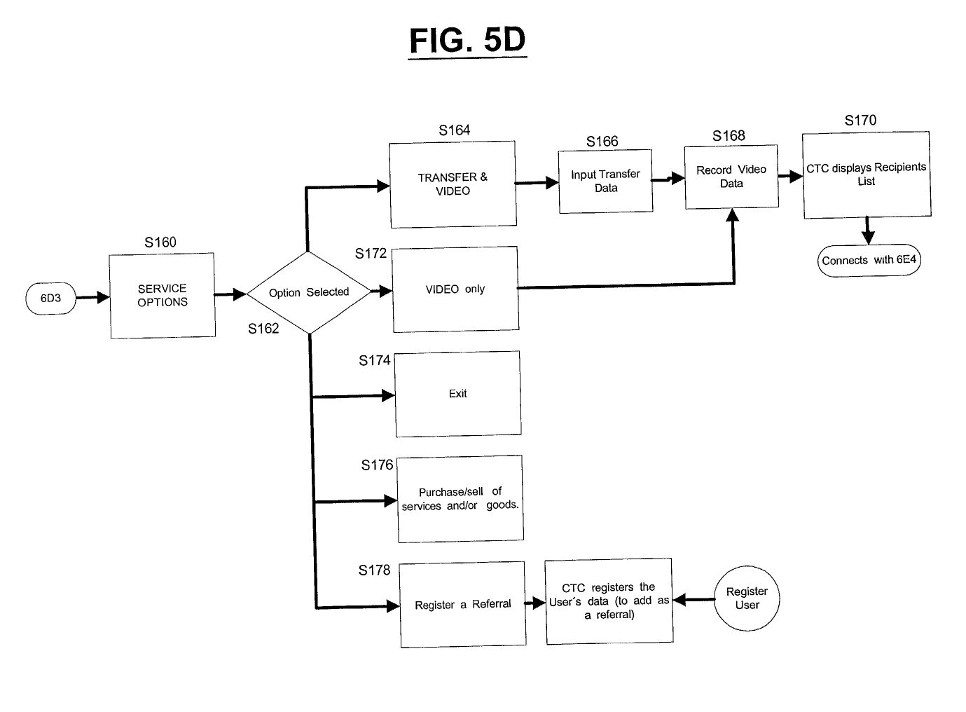

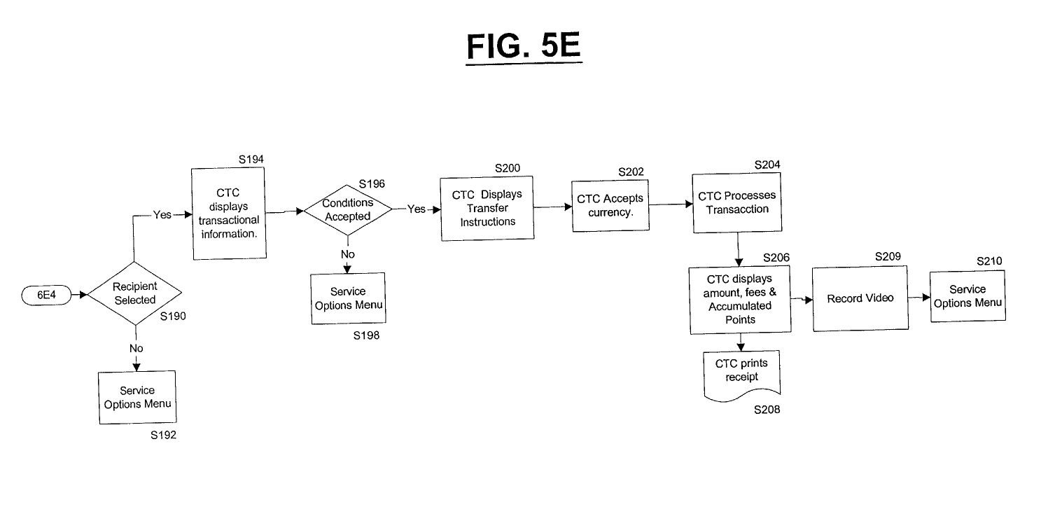

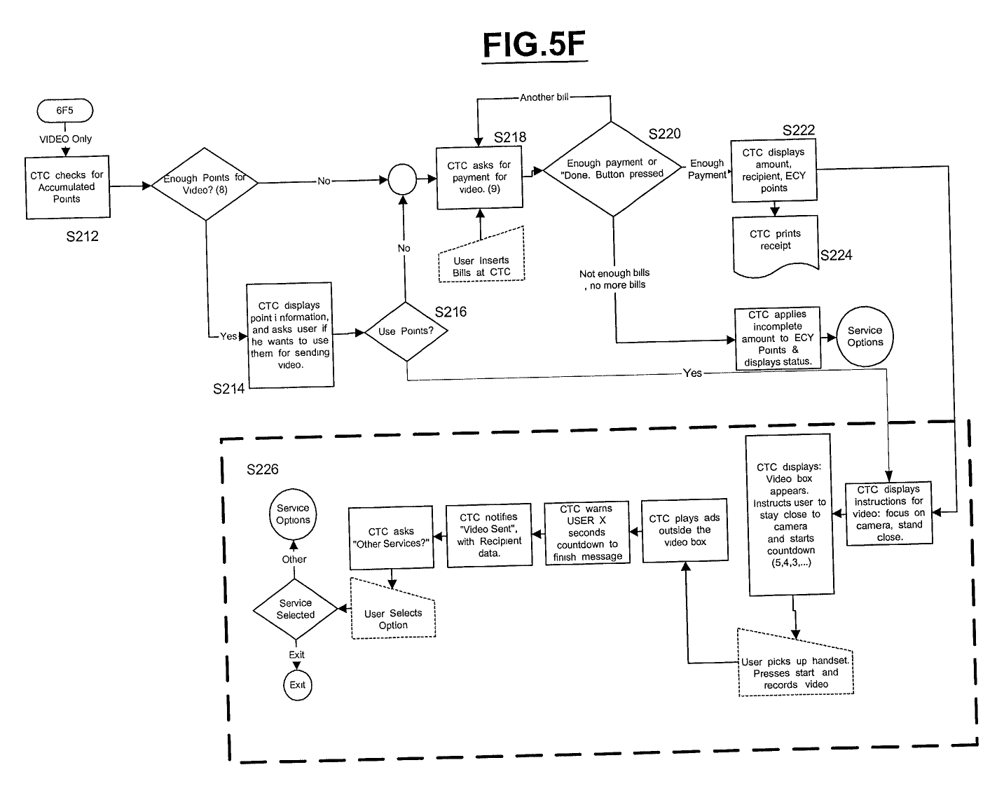

FIGS. 5A, 5B, 5C, 5D, 5E and 5F show a flow chart of the decision logic describing the authentication process, access and use of primary services of the present invention.

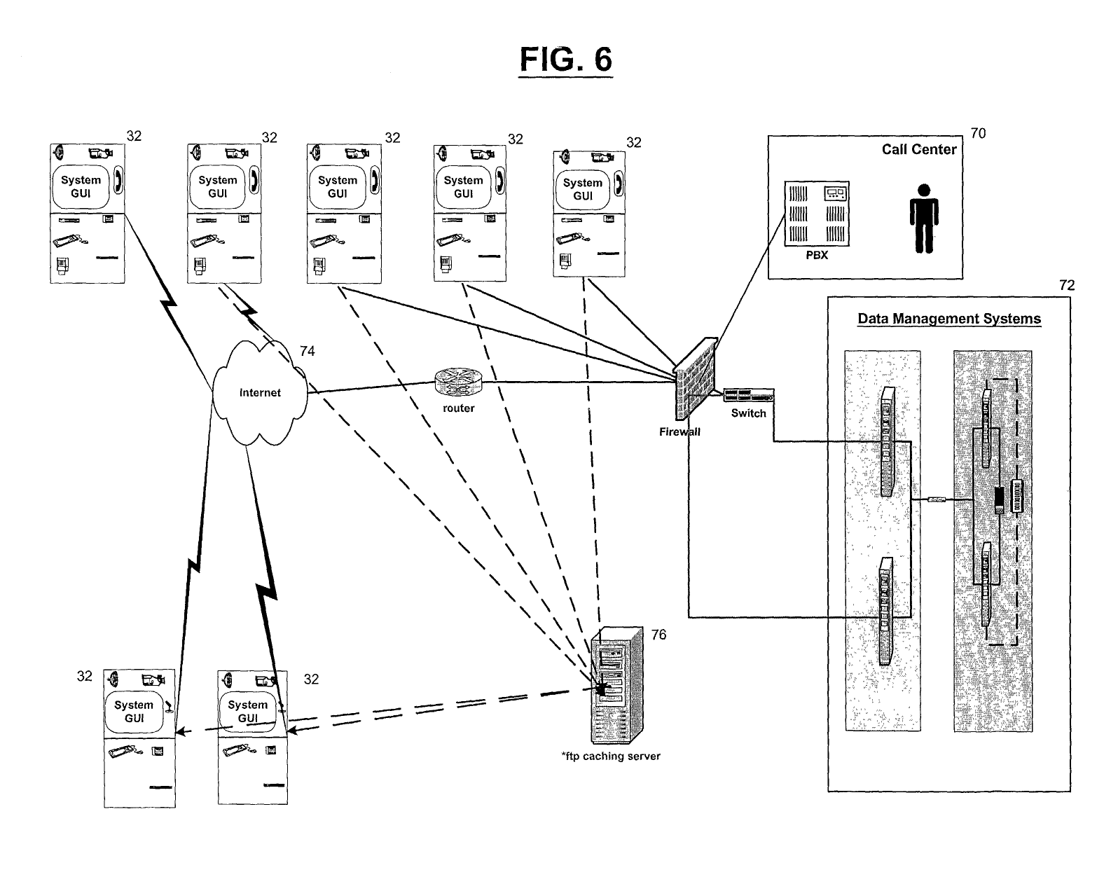

FIG. 6 shows a block diagram of the overall system architecture of a preferred embodiment of the present invention.

### DETAILED DESCRIPTION OF THE PREFERRED EMBODIMENTS

The present invention, in its preferred embodiment, includes a multi-feature, multi-function system of Communication and Transaction Centers that creates an integrated and unique combination of messaging, information-gathering, transaction and commerce capabilities. A user, customer, sender and/or recipient of the communication and transaction center can decide which combination of services works best, whether by using a single function, combination of functions or using all of the functions together.

An important goal of the present invention is to provide a communications context whereby language, cultural, education, financial and other barriers can be readily overcome in a single communication-driven environment. Each user may select among a number of combinable options to create more effective communications and decision-making processes.

The present invention comprises a communications network including one or more Communication and Transaction Centers in the form of web-enabled kiosks, Automatic Teller Machines (ATMs), Personal Computers (PCs), television set-up boxes (to access the Internet), cellular telephones, wireless devices and/or Customer Activated Terminals (CATs), with an ATM feature, connected to the Internet through broadband communications, dial-up connections, wireless communication cache servers, and the like.

Each Center may be located in accessible areas so that individuals who would not normally have access to such an integrated communication system can take advantage of it, much like a telephone booth, which serves to provide a communications option to those who do not have immediate, full-time access to a telephone in that location.

Referring to FIG. 2, in accordance with one embodiment of the present invention, each communication and transaction center (CTC) in the form of a web-enabled kiosk 32 comprises one or more audio speakers 34, a video camera 36, a funds acceptor device 38, a touch screen 40, a telephone handset 42, a keyboard 44 with or without a mouse 46, a magnetic card reader 48 for reading credit/debit/intelligent cards, an optical reader 50 for processing biometrics authentication information, a printer 52 for providing a hard copy record, and a CD-ROM 54 for software download/upload or any other type of interface, a CPU or Panel PC 55 and the software 56

By way of software, the CTC 32 preferably includes a direct funds transfer system, having a secured funds delivery system, for the authorized transfer of financial and other data. The direct funds transfer system comprises a PIN, a password an official ID and/or a biometrics authentication, for identifying and authenticating a recipient of at least one of a message and fund transfer.

The CTC 32 also includes a foreign remittance transaction system for accessing and processing financial data. The foreign remittance transaction system comprises an international currency exchange rate system capable of efficiently transacting international fund transfers.

The CTC 32 also includes a data management system for storing, processing and managing all data. In one embodiment, the data management system comprises several instructions application software useful for managing money transactions, data content, images, and the transmission of video/audio and/or video/audio data. The data management system may also comprise a customer database for storing and processing customer preference, preferred language imaging and personal interest information. The data management system may also comprise the local content management system to display the information of the interest of the specific customer. On the back-end, it may include a user interface software, operated by a touch screen, that has either audio and/or video instructions application software.

The CTC 32 may also include a video conferencing system for providing video and/or audio communications, or real time or by messaging an electronic mail system, and an audio communication system. In addition, the CTC 32 also includes a multi-lingual system for accommodating cross-language and cross-cultural user requirements, the multi-lingual systems will identify from the database in the management system the preferred language of the sender and/or receiver and will display all information in the form of news, instructions, disclosures, contracts and any other means in the preferred language of the sender and/or receiver. In operation, for example, the direct fund transfer system of the preferred embodiment acts as a secured funds delivery system wherein a sender inputs identification information by inserting an ID card, having a magnetic strip, in card reader 50. The sender is authenticated with a Personal Identification Number (PIN), which is put via touch screen 40 or keyboard 44, or via biometrics, such as a facial recognition software resident in reader 50. Other ways can be employed to determine that the identity and authenticity of the sender.

Activation of the communication and transaction system by the user triggers identification of that user and customization, via a variety of service options, of data for that user. For instance, the CTC 32 is capable of displaying user-specific interest information, which may pertain to news from local or distant towns, product specifications, product offerings, etc. Activation also allows the CTC 32 to identify authorized recipients and provides instructions to pay the designated transferred amount(s).

Using the CTC 32, a user can also retrieve status information on non-financial transactions, such as the number of unopened messages (i.e. video and/or audio and/or text), accumulated points generated by all the times the user has performed any type of transaction through the CTC or the users he has referred to the CTC, registered users with whom the user will perform his/hers transactions, and the like.

Using the service options, a user can also initiate a funds transfer request process, which generally begins with a user depositing the correct currency into the fund acceptor device 38, after reviewing information about the whole funds transfer process, including commissions and requirements.

In order to authorize, accept system restrictions, and disclosures, transaction requirements and/or provide funds for the transfer and/or provide funds for the transfer, the user is required to input pertinent funds information, either via keystrokes on the keyboard 44 or via the touch screen 40.

The screen and control features of the user interface in a preferred embodiment of the present invention is shown in FIG. 3. For example, the touch screen 40 comprises several activation/display screen portions, including a video message touch screen portion 56 for displaying imaging information and specific instructions for the activities and/or tasks to be performed in each specific screen. The portion 56 displays the title of the specific activity and/or task to be performed in each screen. The screen 40 also includes one or more command buttons 58 and one or more information and/or publicity screen areas 60. Command button 58 is useful for transmitting command signals according to a user's selection, and screen area 60 displays general and/or publicity-type information.

The screen portion 56 is an area of touch screen 40 used to display graphics corporate information from the company.

The screen portion 62 is an area of touch screen 40 used to display graphics information, such as a picture of the sender or receiver of video messages. The screen portion 62 is also capable of displaying graphics information on goods or services. The portion 64 facilitates entry and display of numerical information.

Continuing with an operation of the CTC 32, a transfer amount is deposited in the funds acceptor device 38 Recipient information is accessed from the data management system, which contains customer's personal information and preferences previously input by the customer. Information on each registered user, together with their pictures, is also optionally available.

The designated transfer amount and other available information, such as the international exchange rate and associated costs, system restrictions and disclosures, and transaction requirements, user authorization may be displayed on the screen 40, so that the sender may be displayed on the screen 40, so that the sender may determine whether to proceed with the transfer.

In one embodiment, currency is deposited in the funds acceptor device 38, so that a transfer based on the tendered amount can be processed. Optionally and alternatively, currency may be tendered electronically, such as through the use of an ATM card, credit card, a pre-paid card, IC or smart card, or electronic wallet. A cancel option is available on the keyboard 44, touch screen 40 or with the call center.

In a preferred embodiment, each transaction can be accompanied by audio and imaging instructions that allow the sender and/or recipient to record/transmit a message with video and/or audio components to be viewed and/or heard on touch screen 40 and/or speakers 34.

In instances with intermediary or without one, is involved in the funds transfer transaction, and the intermediary is an institution charged with delivering the funds to a recipient, the sender may require video confirmation of delivery, or a printed receipt of the transaction. In either case, the CTC 32 is capable of providing such confirmations, whether through printer 52, video 36 and touch screen 40.

Alternatively and optionally, transaction confirmations may be e-mailed to a designated e-mail address, or accessed through the kiosk 32 at a later time. Additionally, images can be downloaded onto a suitable medium and forwarded or transmitted through the connectivity systems of each Communication and Transaction Center. Moreover, using the communications system for identifying and authenticating a recipient of message data, each CTC 32 is configured to transmit audio and/or image message data without a fund transfer.

FIGS. 4A, 4B and 4C show a flow chart describing the process of a new user creating a personal profile containing the user's personal information and preferences, according to one embodiment of the present invention. In this embodiment, the communication and transaction center (CTC) is in the form of a kiosk.

Referring to FIG. 4A for example, at each available operational kiosk, which generally shows advertisements in addition to displays or videos prompting a user to use the kiosk (S10), activity begins when a user touches the display screen of a kiosk (S12). If the display is not touched, the CTC continues to display advertisements and (preferably) eye-catching prompts.

Once the screen is touched, the user is then presented with a variety of combinable service options (S14). Each CTC is capable of providing users with options that include sending or receiving currency, and/or sending or receiving messages, and/or exchanging foreign currency, and/or video conferencing, and/or purchasing goods and/or services and/or selling goods and/or services and the like (S16).

Once a user selects an option (S18), the system performs an initial check to determine whether the user is a new or existing customer (S20). There are different protocols depending on the determination.

For instance, a new user is prompted to select a “Help” option (S22) that is required to register the user. At this junction, the system performs a check to determine if the “Help” option has been selected (S24). If the “Help” option was not selected, the CTC displays further instructions so the user can be registered by himself/herself or with the direct support of an on-site Assistant if such is the case (S26); if the “Help” option was selected, the CTC automatically contacts the Call Center via telephone (S28).

Communication occurs between a Call Center Operator and the new user in order to obtain pertinent information to properly register the user and create a personal profile (S30). Alternatively and optionally, the CTC may display images or play instructional videos to facilitate the registration and personal profile creation process (S32).

During the course of this communication, the Call Center Operator or the on-site Assistant preferably captures personal data and desired recipient location information about the new user (S34), who in turn accepts and validates the data (S36).

In addition, during communication with the new user, the Call Center Operator or the on-site Assistant preferably assists the new user in obtaining an identification (ID) card such as, for instance, by assisting the new user in obtaining an ID card from the CTC (S38), and after dispensing (S40), activating the ID card (S42).

In one embodiment, the ID card is activated by physically “swiping” the card through the CTC (S42), which captures the card's identification information (S46) and displays a PIN capture screen (S48). Alternatively and optionally, the CTC can perform biometrics recognition.

At this juncture, the Call Center asks a user to input his or her PIN (S50) or, alternatively, the CTC may initiate biometrics recognition operations. Preferably, the user inputs the PIN twice (S52) before the CTC sends card ID and PIN, and/or biometrics information to the Call Center, along with the CTC identification information (S54). Upon receipt, the Call Center assigns the information to the user's data file (S56), and asks the user to swipe the card again before hanging up (S58). The CTC then presents the various service options to the user (S60).

Referring back to FIG. 4A, at junction S24, where the system performs a check to determine if the “Help” option has been selected. If the “Help” option is selected, the CTC screen displays an Assistant User ID and Password Input Screen (S70) and a Customer Information Screen (S72), which prompts the user to input personal data (S74). The system also provides a listing of recipient locations for the user to choose from (S76). It captures all input data, including selected recipient location(s) (S78).

The user's database interface accepts the data, validates referrals from whom he was directed to use the service so the referrer can accumulate points from the user usage of the CTC, and displays selected recipient locations (S80). The Assistant obtains an ID card from the CTC (S82), swipes the card and dispenses it to the user (S84). Internally, the CTC captures the card's ID (S86), and displays the PIN capture screen or performs biometrics recognition (S88).

In one embodiment, the Assistant asks the user to input a PIN or the CTC performs biometrics recognition (S90). Preferably, the user inputs the PIN twice (S92) before the CTC assigns a card ID and PIN, and/or biometrics information to the user's data file (S94). Upon receipt, the Assistant signs off, thanking the user, asking him/her to swipe the card again (S96). The CTC then presents the various service options to the user (S98).

Referring now to FIGS. 5A-5F, there is shown a flow chart of the decision logic describing the authenticating process, access and use of main services of the present invention. The block 100 in FIG. 5A is similar to the block 100 in FIG. 4A, and the process steps contained therein, for brevity.

Once it is determined that the user is an existing customer, the user is prompted to swipe his or her card (S102). If the system detects that a card has not been swiped, it assumes that the user is an existing customer but without a card presently (S104). Subsequently, the CTC displays an input screen for card ID and PIN input (S106).

At this juncture, the user essentially has two options: input the appropriate ID and PIN information, or select the “No Card” button. The system first prompts as to whether the ID and PIN information has been input (S108).

If the ID and PIN information was not input, the system assumes that the “No Card” button was depressed and the CTC displays instructions to obtain a new ID (S112), and is prompted to select a Help option (S114). The Help option includes the options to either use the Call Center or the CTC's on-site Assistant if the CTC is located in an open area.

A determination is made whether the Call Center option was selected (S116). If so, the CTC displays instructions on Call Center use (S118), such as instructions to pick up a handset and depress the call button. The Call Center then accepts the user's information (S120).

If, on the other hand, the Call Center option is not selected, the CTC displays instructions on how to ask the on-site Assistant for help (S122). In an exemplary embodiment, the user may ask the Assistant for help (S124), and the CTC may then display a screen for the user to enter his ID and/or password (S128). Once the user's ID and password information is input, the screen displays an ID replacement screen (S128) for input of additional user information.

If, on the other hand, it is determined that the user is an existing user having a valid card and ID, see FIG. 5A, and the CTC validates the ID and PIN information (S110), the user is now authenticated and is prompted as to whether the user is a first-time user (S140). See FIG. 5C.

If so, the CTC provides welcome messages, which may be customizable, and photographs the user (S142). The data management system also performs a system check to verify that the user's profile/file does not contain a photograph. Once the picture is taken, the data management system containing the user's profile/file is updated with the user's photograph, and the CTC presents the user with a variety of service options (S144) for selection as desired.

On the contrary, if there is a user picture already on file, the CTC displays a customized welcome message and the content management system will identify from the database in the management system the location from where the sender and/or receiver comes from and will display information and news of their personal interest from such home place, and presents the user with the option to check for any pending transactions and/or messages (S146). If there are no pending transactions, the user is presented with a variety of service options (S144) for selection as desired. If, for example, there is a pending fund transfer transaction, the CTC displays information pertaining to the fund transfer (S148), such as payment data, and prints a receipt containing information about the transfer and/or the recipient/sender (S150).

If a video accompanies the fund transfer (S152), as is the case if there is a pending video transaction, the CTC displays the video for user viewing (S154), before prompting the user on whether to view other pending transactions (S158). If there is no video component to the fund transfer information, then the user is presented with the service options menu for selection as desired (S160). If additional viewing of other pending transactions is desired, the process returns to the S146 process block.

Referring now to FIG. 5D, there is illustrated a process flow of one embodiment of service options (S160) provided by the present invention. The service options menu, for example, includes a selection (S162) for initiating a funds transfer transaction accompanied by a video (S164). For this selection, a user is substantially prompted to input funds transfer data (S166) and record the video data (S168) before the CTC displays a recipient list (S170) for user selection.

If the video option only is selected (S172), the CTC displays a recipient list (S170) for user selection before user is prompted to record the video data (S168).

Exiting the CTC (S174) is also an option substantially available throughout CTC use. If the exit option is selected, the CTC provides the appropriate farewell/thank you messaging data.

The CTC also provides a user with the opportunity to purchase and/or sell goods and services (S176). These commercial transactions will be displayed on the screen so the user, either through the touch screen or the keyboard, can select and purchase. The CTC also provides a referral service option (S178), this system feature will help users to include new users to whom they can make transactions among them and also the users who is referring will be able to accumulate points from the frequent usage of their referrals.

Referring now to FIG. 5E, once the CTC displays a recipient list for user selection, the user is prompted to select a recipient (S190). If no recipient is selected, the CTC presents the service options menu (S192).

However, if the desired number of recipients have been selected and/or added, the CTC displays various information related to the desired transaction (S194), such as legal information, recipient data, transactional fees, etc. The user (i.e. in this case a sender) reviews the information and is prompted as to whether the conditions of the transaction are acceptable (S196). If not, the user is provided with the service options menu (S198).

If the user determines that conditions are acceptable, the CTC displays transfer instructions (S200) and prepares for accepting currency (S202), including providing a display message with the amount tendered. Once the proper amount is tendered, the CTC processes the transaction (S204) and displays completed transaction summary information, such as the transaction amount, fees, the points the user will accumulate with the payment and usage of the transaction, the number of points will depend on several factors like the amount of the payment, type of transaction, special promotions, etc. (S206). A receipt is printed of the transaction (S208) and the service options menu (S210) is present for user selection as desired. In addition, a video of the transaction may be recorded (S209).

FIG. 5F is a flow chart describing the decision logic for sending video where the system checks for accumulated points (S212) and the user can decide to pay the video either with cash or with accumulated points (S214). If the user decides to pay with cash the CTC will be asking for the money until the complete amount is inserted into the bill acceptor (S220), once the complete information about recipient, amount paid, new points accumulated is accepted by the user, the CTC prints a receipt with all the information (S224), after this the user starts to receive instructions to record video (S168).

In addition to the funds transfer capability described above, each Communication and Transaction Center preferably provides video conferencing (S226) and e-mail capabilities, which enable users to engage in real time communications accompanied by video or to send video messages with audio. A variety of editing features, such as printing, downloading, forwarding and emailing, are provided for manipulating image, video or message data.

Each CTC also preferably provides internet access to facilitate active or passive manipulation of electronic information, including news (local or remote) to where the user is located. Active manipulation includes searching, editing and/or disseminating desired information. Passive manipulation includes browsing and reviewing of information.

For instance, any user-selected data obtained via email, from the internet or from stored files, can be selectively accessed, forwarded to a specified address (such as another kiosk) or discussed in real time in a video conference with another party who has access to a kiosk in the system or to a compatible system. A feature of this aspect of the system is that both parties can view the item under discussion on their screens while also viewing the other individuals involved in the real time communication.

Another feature of the present invention allows audio discussion without images of the communicators or any image at all. As with other transactions available through the system, communications is preserved or confirmed through printouts, downloading and e-mail forwarding, for example. Through the CTC, a user is also capable of performing online purchase and sale transactions involving goods and services.

FIG. 6 shows a plurality of communication and transaction centers 32, call center 70 and data management systems 72 connected to a global network, such as the Internet 74, in accordance with one embodiment. This system also accommodates Internet access through home electronic equipment, such as personal computers, and television and cable devices. Connections to the Internet is achieved through broadband communications, dial-up connections, cache servers 76 and the like.

It should be understood by those skilled in the art that the present description is provided only by way of an illustrative example and should in no manner be construed to limit the invention as described herein. Further, since numerous modifications and variations will readily occur to those skilled in the art, it is not desired to limit the invention the exact construction illustrated and described. For example, voice recognition programming and equipment can be used to supplement or replace the keyboard entry feature. Accordingly, all suitable modifications and equivalents may be resorted to as falling within the scope of the invention.

What is claimed is:

1. A multi-lingual communication and transaction system for performing transactions and generating communications data, involving at least one of financial data and message data, said system comprising:
a multi-lingual interpreter and translator that generates at least one of funds communications and interpreted communications, wherein said multi-lingual interpreter and translator generates said funds communications in one of a plurality of currencies in response to receipt of financial data, and generates interpreted communications in response to receipt of message data.

2. The communication and transaction system according to claim 1, further comprising:
data managers for at least one of storing, processing and managing said communications data.

3. The communication and transaction system of claim 2, wherein said data manager further comprises a customer database for storing and processing customer preference and personal interest information.

4. The communication and transaction system of claim 2, wherein said data manager further comprises a user interface.

5. The communication and transaction system of claim 4, wherein said user interface is a touch screen facilitating at least one of an audio, visual and audio instructions application software.

6. The communication and transaction system of claim 4, wherein said interface is a screen having at least one of a keyboard, a mouse and a track ball, and wherein said at least one of a keyboard, mouse and track ball is supported by at least one of audio, visual and audio instructions application software.

7. The communication and transaction system of claim 2, wherein said data manager further comprises a communications system for transmitting at least one of video, audio, and video and audio data.

8. The communication and transaction system of claim 2, wherein said data manager further comprises a remittance transaction system for processing money transactions either through the use of at least one of a hardware device and a software device.

9. The communication and transaction system of claim 2, wherein said data manager further comprises a content management system.

10. The communication and transaction system of claim 3, wherein said customer database is configured for at least one of storing and processing images.

11. The communication and transaction system of claim 1, wherein said multi-lingual communication and transaction system comprises an authentication system for identifying and authenticating a recipient of a fund transfer.

12. The communication and transaction system of claim 1, further comprising:
an authentication system for identifying and authenticating a recipient of message data.

13. The communication and transaction system of claim 11, wherein said authentication system employs biometrics authentication.

14. The communication and transaction system of claim 12, wherein said authentication system employs biometrics authentication.

15. The communication and transaction system of claim 1, wherein said multi-lingual communication and transaction system comprises an international currency exchange rate system capable of efficiently transacting international fund transfers.

16. The communication and transaction system of claim 1, further comprising:
a video conferencing system for direct real time communications accompanied by at least one of video and audio data.

17. The communication and transaction system of claim 1 further comprising:
a video conferencing system for messaging communications accompanied by at least one of video and audio data.

18. The communication and transaction system of claim 1, further comprising:
an electronic mail system.

19. The communication and transaction system of claim 1, further comprising:
an audio communication system.

20. The communication and transaction system of claim 1, wherein said communication and transaction system is a web-enabled kiosk.

21. The communication and transaction system of claim 1, wherein said communication and transaction system is an automated teller machine.

22. The communication and transaction system of claim 1, wherein said communication and transaction system is a customer activated terminal.

23. The communication and transaction system of claim 1, wherein said communication and transaction system is a television set-up box.

24. The communication and transaction system of claim 1, wherein said communication and transaction system is a personal computer.

25. The communication and transaction system of claim 1, wherein said communication and transaction system is a cellular telephone.

26. The communication and transaction system of claim 1, wherein said communication and transaction system is for use in a data communications network comprising at least one of intranet and Internet.

27. A method for providing interactive communications and performing transactions, said method comprising:
presenting an authorized user with information relative to the authorized user's identification;
performing a system check for pending financial transactions associated with the authorized user, and generating financial data;
performing a system check for pending message communications associated with the authorized user, and generating message data;
presenting the authorized user with at least one of service options and transaction options for responding to said message data generated and said financial data generated; and
processing said at least one of service options and transaction options presented to said authorized user.

28. The method of producing interactive communications and performing transactions of claim 27, further comprising:
offering a record of said at least one of said service options and transaction options processed.

29. The method according to claim 27, further comprising entering of identifying data.

30. The method according to claim 27, wherein said entering of identifying data further includes touching a screen.

31. The method according to claim 27, further comprising:
determining if user data entered corresponds to data representing said authorized user.

32. The method according to claim 27, wherein said entering of identifying data further includes providing at least one of an identification card and a biometrics identifier.

33. The method according to claim 31, wherein said determining if user data entered corresponds to data representing said authorized user further comprises using at least one of personal identification numbers, passwords and biometrics authentication.

34. A communication software suite comprising:
a multi-lingual system for accommodating cross-language and cross-cultural user requirements;
a foreign remittance transaction system for accessing and processing data as accommodated by said multi-lingual system; and
a direct funds delivery system, having a secured funds delivery system, for transfers of said data.

35. The communication software suite according to claim 34, further comprising:
a data management system for at least one of storing, processing and managing the data.

36. The communication software suite according to claim 35, wherein said data management system further comprises a customer database for at least one of storing and processing at least one of customer preference and personal interest information.

37. The communication software suite according to claim 34, further comprising:
user interface software operated by a touch screen and having at least one of an audio, visual and audio instructions application software.

38. The communication software suite according to claim 34, further comprising:
application software for sending at least one of video, audio, and video and audio data.

39. The communication software suite according to claim 34, further comprising:
application software for money transactions.

40. The communication software suite according to claim 34, further comprising:
application software for content management.

41. The communication software suite according to claim 36, wherein said customer database is capable of at least one of storing and processing an image of a customer.

42. The communication software suite according to claim 34, wherein said direct funds transfer system comprises an authentication system for at least one of identifying and authenticating a recipient for at least one of a message and fund transfer.

43. The communication software suite according to claim 42, wherein said authentication system employs biometrics authentication.

44. The communication software suite according to claim 34, wherein said foreign remittance transaction system comprises an international currency exchange rate system capable of efficiently transacting international fund transfers.

45. The communication software suite according to claim 34, further comprising:
a video conferencing system for direct real time communications accompanied by at least one of video and audio.

46. The communication software suite according to claim 34, further comprising:
a conferencing system for messaging accompanied by video and audio.

47. The communication software suite according to claim 34, further comprising:
an electronic mail system.

48. The communication software suite according to claim 34, wherein said communication software suite is an audio communications system.

49. The communication software suite according to claim 34, wherein said communication software suite is a web-enabled kiosk.

50. The communication software suite according to claim 34, wherein said communication software suite is an automated teller machine.

51. The communication software suite according to claim 34, wherein said communication software suite is a customer activated terminal.

52. The communication software suite according to claim 34, wherein said communication software suite is a television set-up box.

53. The communication software suite according to claim 34, wherein said communication software suite is a personal computer.

54. The communication software suite according to claim 34, wherein said communication software suite is a wireless application protocol of a cellular telephone.

55. A communication and software suite according to claim 34, for use in a data communication network comprising at least one of intranet and Internet.

56. A communication and transaction system for transferring funds and message data together, said system comprising:
multi-lingual means for interpreting and translating financial transactions in one or more languages; and
remittance transaction means for at least one of processing, sending and receiving said financial transactions.

57. The communication and transaction system according to claim 56, further comprising:
data management means for at least one of storing, processing and managing financial and communications data.

58. The communication and transaction system of claim 57, wherein said data management means further comprises a customer database means for at least one of storing and processing customer preference and personal interest information.

59. The communication and transaction system of claim 56, further comprising:
a user interface means for interfacing with said system by a touch screen having at least one of an audio, video and audio instructions application software.

60. The communication and transaction system of claim 56, further comprising:
a communications means for sending at least one of video, audio, video and audio data.

61. The communication and transaction system of claim 56, further comprising:
a remittance transaction means for processing money transactions.

62. The communication and transaction system of claim 56, further comprising:
a content management means for content management.

63. The communication and transaction system of claim 58, wherein said customer database means is configured for at least one of storing and processing images.

64. The communication and transaction system of claim 56, wherein said foreign remittance transaction means comprises an authentication system for at least one of identifying and authenticating a recipient for a fund transfer.

65. The communication and transaction system of claim 60, wherein said communications means comprises an authentication system for at least one of identifying and authenticating a recipient for message data.

66. The communication and transaction system of claim 64, wherein said authentication system employs biometrics authentication.

67. The communication and transaction system of claim 65, wherein said authentication system employs biometrics authentication.

68. The communication and transaction system of claim 56, wherein said foreign remittance transaction means comprises an international currency exchange rate system capable of efficiently transacting international fund transactions.

69. The communication and transaction system of claim 60, wherein said communications means further comprises a video conferencing means for direct real time communications accompanied by at least one of video and audio.

70. The communication and transaction system of claim 60, wherein said communications means further comprises a video conferencing means for messaging communications accompanied by at least one of video and audio.

71. The communication and transaction system of claim 60, wherein said communications means further comprises an electronic mail system.

72. The communication and transaction system of claim 60, wherein said communications means further comprises an audio communication system.

73. The communication and transaction system of claim 56, wherein said communication and transaction system is a web-enable kiosk.

74. The communication and transaction system of claim 56 wherein, said communication and transaction system is an automated teller machine.

75. The communication and transaction system of claim 56, wherein said communication and transaction system is a customer activated terminal.

76. The communication and transaction system of claim 56 wherein said communication and transaction system is a television set-up box.

77. The communication and transaction system of claim 56, wherein said communication and transaction system is a personal computer.

78. The communication and transaction system of claim 56, wherein said communication and transaction system is a wireless application protocol of a cellular telephone

79. The communication and transaction system of claim 56, wherein said communication and transaction system is for use in a data communication network comprising at least one of intranet and Internet.

80. The communication and transaction system according to claim 1, wherein said at least one of funds communications and interpreted communications is an electronic commerce communication.

81. The method according to claim 27, wherein said at least one of the service options and transaction options is an electronic commerce option.

82. The communication software suite according to claim 34, further comprising:
an electronic commerce system for communicating said data.

83. The communication software suite according to claim 34, wherein at least some of said data is financial data.

84. The communication software suite according to claim 34, wherein said transfers are authorized.

85. The communication and transaction system according to claim 56, wherein said at least one of processing, sending and receiving financial transactions is in electronic commerce.
